(19) United States
(12) Patent Application Publication
(10) Pub. No.: US 2026/0067736 A1
(43) Pub. Date: Mar. 5, 2026

(54) PROCESSING METHOD, COMMUNICATION DEVICE AND STORAGE MEDIUM

(71) Applicant: Shanghai Transsion Co., Ltd., Shanghai (CN)

(72) Inventors: Sha WANG, Shanghai (CN); Wei HUANG, Shanghai (CN)

(73) Assignee: Shanghai Transsion Co., Ltd., Shanghai (CN)

(21) Appl. No.: 19/380,751

(22) Filed: Nov. 5, 2025

Related U.S. Application Data
(63) Continuation of application No. PCT/CN2023/093659, filed on May 11, 2023.

(51) Int. Cl. H04W 24/10

(52) U.S. Cl. CPC H04W 24/10

(57) ABSTRACT

A processing method includes: selecting or determining a number N of channel state information (CSI) s to be included within one CSI report based on downlink information, where N is greater than or equal to 1; and reporting the CSI report. The technical solution of the present application can solve the problem that if multiple CSIs corresponding to multiple antenna port numbers need to be reported, multiple CSIs reports must be reported at different times, which may result in multiple CSIs reporting and/or CSI expiration, thereby achieving the purpose of reducing the number of CSI reports and/or ensuring the timeliness of CSI.

### CROSS-REFERENCE TO RELATED APPLICATIONS

This application is a continuation application of International Application No. PCT/CN2023/093659, filed on May 11, 2023, the content of which is incorporated herein by reference in its entirety.

### TECHNICAL FIELD

The present application relates to the technical field of communication, and in particular to a processing method, a communication device and a storage medium.

### BACKGROUND

In existing protocols, a network device (for example, a base station) transmits a channel state information-reference signal (CSI-RS) to a terminal device (for example, a mobile phone). The terminal device measures the CSI-RS and reports a channel state information (CSI) report to the network device. The network device determines transmission parameters of a physical downlink shared channel (PDSCH), such as a precoding matrix and a rank, according to the CSI report.

In the process of conceiving and implementing the present application, the inventors found that one CSI report can only report CSI corresponding to one antenna port number. When CSI corresponding to multiple antenna port numbers need to be reported, multiple CSIs reports corresponding to the multiple antenna port numbers need to be reported at different times, which may lead to excessive CSI reporting and/or CSI expiration; and/or, if multiple CSIs corresponding to multiple antenna port numbers are reported within one CSI report, there is a problem of how to distinguish the antenna port numbers corresponding respectively to the multiple CSIs to be included within one CSI report.

The preceding description is intended to provide general background information and does not necessarily constitute prior art.

### SUMMARY

The main purpose of the present application is to provide a processing method, a communication device and a storage medium. The technical solution of the present application can reduce the number of CSI reports and/or ensure the timeliness of CSI; and/or, when a CSI Report contains multiple CSIs, the technical solution of this application can also help the network device effectively identify the specific antenna port numbers corresponding to the multiple CSIs contained in a CSI Report.

The present application provides a processing method, which can be applied to a terminal device (such as a mobile phone), including:
selecting or determining a number N of channel state information (CSI) s to be included within one CSI report based on downlink information, where N is greater than or equal to 1; and
reporting the CSI report.

Optionally, the downlink information includes at least one of the following:
downlink control information;
radio resource control information; and
media access control information.

Optionally, the number N of CSIs to be included within the CSI report is determined based on at least one of the following:
determining N according to an indication field in the downlink control information that specifies a preferred number of channel state information;
determining N according to an antenna port numbers to be measured configured by the downlink information; and
determining N according to terminal device capabilities and service requirements.

Optionally, N is less than or equal to the antenna port numbers to be measured configured by the downlink information.

Optionally, a CSI report includes at least one of the following:
information of antenna port number indicator, where the antenna port number indicator indicates N different antenna port numbers corresponding respectively to the N CSIs; and
the N CSIs corresponding respectively to N different antenna port numbers, where at least one CSI in the N CSIs includes a wideband channel quality indicator and/or a rank indicator.

Optionally, the antenna port number indicator includes at least one of the following:
a CSI-RS resource identifier field corresponding to N different antenna port numbers;
a CSI-RS resource set identifier field corresponding to N different antenna port numbers;
a logical index number field of a CSI-RS resource identifier corresponding to N different antenna port numbers;
a logical index number field of a CSI-RS resource set identifier corresponding to N different antenna port numbers; and
an index position field of N different antenna port numbers in a resource pool.

The present application further provides a processing method, which can be applied to a network device (such as a base station), including:
transmitting downlink information so that a terminal device selects or determines a number N of channel state information (CSI) s to be included within one CSI report based on the downlink information, where N is greater than or equal to 1.

Optionally, the downlink information includes at least one of the following:
downlink control information;
radio resource control information; and
media access control information.

Optionally, the CSI report includes at least one of the following:
information of antenna port number indicator, where the antenna port number indicator indicates N different antenna port numbers corresponding respectively to the N CSIs; and
the N CSIs corresponding respectively to N different antenna port numbers, where at least one CSI in the N CSIs includes a wideband channel quality indicator and/or a rank indicator.

Optionally, the antenna port number indicator includes at least one of the following:
a channel state information-reference signal (CSI-RS) resource identifier field corresponding to N different antenna port numbers;
a CSI-RS resource set identifier field corresponding to N different antenna port numbers;
a logical index number field of a CSI-RS resource identifier corresponding to N different antenna port numbers;
a logical index number field of a CSI-RS resource set identifier corresponding to N different antenna port numbers; and
an index position field of N different antenna port numbers in a resource pool.

Optionally, the method further includes:
receiving a CSI report; and determining transmission parameters for physical downlink shared channel transmission according to the CSI report.

The present application further provides a processing apparatus, including:
a determination module configured to select or determine, based on downlink information, a number N of CSIs to be included within one CSI report, where N is greater than or equal to 1; and
a reporting module configured to report the CSI report.

The present application further provides a processing apparatus, including:
a transmitting module configured to transmit downlink information so that a terminal device selects or determines, based on the downlink information, a number N of CSIs to be included within one CSI report; and
a receiving module configured to receive the CSI report and determine transmission parameters for PDSCH transmission based on the CSI report.

The present application further provides a communication device, including: a memory, a processor, and a processing program stored in the memory and executable on the processor, and the processing program implements any of the processing methods described above when executed by the processor.

The communication device mentioned in the present application may be a terminal device (such as an intelligent terminal, such as a mobile phone) or a network device (such as a base station), and the specific reference needs to be clarified in the context.

The present application further provides a storage medium, a computer program is stored in the storage medium, and when the computer program is executed by the processor, the processing method described in any of the above embodiments is implemented.

In technical solutions of the present application, the terminal device selects or determines, based on downlink information, a number N of CSIs to be included within one CSI report, where N is greater than or equal to 1, and reports the CSI report. This can solve the problem that if multiple CSIs corresponding to different antenna port numbers need to be reported, multiple CSIs reports must be reported at different times, which may result in multiple CSIs reporting and/or CSI expiration, thereby achieving the effect of reducing the number of CSI reports and/or ensuring the timeliness of the CSI. And/or, the technical solution of the present application provides a method for distinguishing multiple CSIs within one CSI report that correspond to different antenna port numbers, thereby enabling the network device to effectively identify multiple CSIs within the reported CSI report.

### BRIEF DESCRIPTION OF THE DRAWINGS

The accompanying drawings, which are incorporated in and constitute a part of this specification, illustrate embodiments consistent with the present application and together with the description, serve to explain the principles of the present application. In order to explain the technical solutions of the embodiments of the present application more clearly, the drawings needed to be used in the description of the embodiments will be briefly introduced below. Obviously, for those of ordinary skill in the art, other drawings can be obtained based on these drawings without exerting creative efforts.

FIG. 1 is a schematic diagram of hardware structure of a mobile terminal that implements various embodiments of the present application.

FIG. 2 is a communication network system architecture diagram according to an embodiment of the present application.

FIG. 3 is a schematic diagram of hardware structure of a controller 140 involved in a control method according to an embodiment of the present application.

FIG. 4 is a schematic diagram of hardware structure of a network node 150 involved in the control method according to an embodiment of the present application.

FIG. 5 is a schematic diagram of an interaction process between a terminal device and a network device in the control method according to a first embodiment of the present application.

FIG. 6 is a schematic diagram of an interaction process between a terminal device and a network device in the control method according to a second embodiment of the present application.

FIG. 7 is a schematic diagram of an interaction process between a terminal device and a network device in the control method according to a third embodiment of the present application.

FIG. 8 is a schematic diagram of an interaction process between a terminal device and a network device in the control method according to a fourth embodiment of the present application.

FIG. 9 is a schematic diagram of an interaction process between a terminal device and a network device in the control method according to a fifth embodiment of the present application.

FIG. 10 is a schematic diagram of an interaction process between a terminal device and a network device in the control method according to a sixth embodiment of the present application.

FIG. 11 is a schematic diagram of an interaction process between a terminal device and a network device in the control method according to a seventh embodiment of the present application.

The realization of the purpose, functional features and advantages of the present application will be further described in conjunction with the embodiments and with reference to the accompanying drawings. The above-mentioned drawings have shown clear embodiments of the present application, which will be described in more detail later. These drawings and textual descriptions are not intended to limit the scope of the concept of the present application in any way, but to illustrate the concept of the present application to those skilled in the art by referring to specific embodiments.

### DETAILED DESCRIPTION OF THE EMBODIMENTS

Exemplary embodiments will be described in detail herein, examples of which are illustrated in the accompanying drawings. When the following description refers to the drawings, unless otherwise indicated, the same numbers in different drawings refer to the same or similar elements. The implementations described in the following exemplary embodiments do not represent all implementations consistent with the present application. Rather, they are provided only as examples of apparatus and methods consistent with aspects of the present application as detailed in the appended claims.

It should be noted that in this document, the terms “comprise”, “include” or any other variants thereof are intended to cover a non-exclusive inclusion. Thus, a process, method, article, or system that includes a series of elements not only includes those elements, but also includes other elements that are not explicitly listed, or also includes elements inherent to the process, method, article, or system. If there are no more restrictions, the element defined by the sentence “including a . . . ” does not exclude the existence of other identical elements in the process, method, article or system that includes the element. In addition, components, features, and elements with the same name in different embodiments of the present application may have the same or different meanings. Its specific meaning needs to be determined according to its explanation in the specific embodiment or further combined with the context in the specific embodiment.

It should be understood that although the terms first, second, third, etc. may be used herein to describe various information, the information should not be limited to these terms. These terms are only used to distinguish information of the same type from one another. For example, without departing from the scope of this document, first information may also be called second information, and similarly, second information may also be called first information. Depending on the context, the word “if” as used herein may be interpreted as “at” or “when” or “in response to a determination”. Furthermore, as used herein, the singular forms “a”, “an” and “the” are intended to include the plural forms as well, unless the context indicates otherwise. It should be further understood that the terms “comprising”, “including” indicate the existence of features, steps, operations, elements, components, items, species, and/or groups, but does not exclude the existence, occurrence or addition of one or more other features, steps, operations, elements, components, items, species, and/or groups. The terms “or”, “and/or”, “comprising at least one of” and the like used in the present application may be interpreted as inclusive, or mean any one or any combination. For example, “comprising at least one of: A, B, C” means “any of: A; B; C; A and B; A and C; B and C; A and B and C”. As another example, “A, B, or C” or “A, B, and/or C” means “any of the following: A; B; C; A and B; A and C; B and C; A and B and C”. Exceptions to this definition will only arise when combinations of elements, functions, steps or operations are inherently mutually exclusive in some way.

It should be understood that although the various steps in the flowchart in the embodiment of the present application are displayed sequentially as indicated by the arrows, these steps are not necessarily executed sequentially in the order indicated by the arrows. Unless otherwise specified herein, there is no strict order restriction on the execution of these steps, and they can be executed in other orders. Moreover, at least some of the steps in the figure may include multiple sub-steps or multiple stages, these sub-steps or stages are not necessarily executed at the same time, but can be executed at different times. The execution sequence thereof is not necessarily performed sequentially, but may be performed alternately or alternately with at least one part of other steps or sub-steps or stages of other steps.

Depending on the context, the words “if” as used herein may be interpreted as “at” or “when” or “in response to determining” or “in response to detecting”. Similarly, depending on the context, the phrases “if determined” or “if detected (the stated condition or event)” could be interpreted as “when determined” or “in response to the determination” or “when detected (the stated condition or event)” or “in response to detection (the stated condition or event)”.

It should be noted that in this article, step codes such as S1 and S2 are used for the purpose of expressing the corresponding content more clearly and concisely, and do not constitute a substantial limitation on the sequence. When implementing the step, those skilled in the art may execute S2 first and then S1, etc., but these should all be within the scope of the present application.

It should be understood that the specific embodiments described here are only used to explain the present application, and are not intended to limit the present application.

In the following description, the use of suffixes such as “module”, “part” or “unit” for denoting elements is only for facilitating the description of the present application and has no specific meaning by itself. Therefore, “module”, “part” or “unit” may be used in combination.

The communication device mentioned in the present application can be a terminal device (such as a mobile terminal, specifically a mobile phone) or a network device (such as a base station). The specific reference needs to be clarified in the context. The terminal device can be implemented in various forms. For example, the terminal device described in the present application can include a mobile phone, a tablet computer, a notepad computer, a hand-held computer, a personal digital assistants (PDA), a portable media player (PMP), a navigation device, a wearable device, a smart bracelet, a pedometer and other terminal devices, as well as a fixed terminal device such as a digital TV and a desktop computer.

The present application takes a mobile terminal as an example to illustrate. Those skilled in the art will understand that, in addition to elements specifically used for mobile purposes, the configuration according to the embodiments of the present application can also be applied to the fixed terminal device.

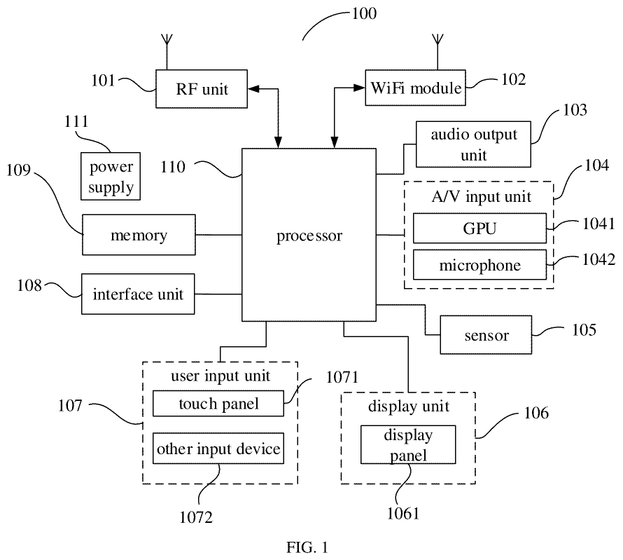

As shown in FIG. 1, FIG. 1 is a schematic structural diagram of a hardware of a mobile terminal that implements various embodiments of the present application. The mobile terminal 100 can include a Radio Frequency (RF) unit 101, a Wi-Fi module 102, an audio output unit 103, an audio/video (A/V) input unit 104, a sensor 105, a display unit 106, a user input unit 107, an interface unit 108, a memory 109, a processor 110, a power supply 111 and other components. Those skilled in the art can understand that the structure of the mobile terminal shown in FIG. 1 does not constitute a limitation on the mobile terminal. The mobile terminal can include more or fewer components, or a combination of some components, or differently arranged components than shown in the figure.

Hereinafter, each component of the mobile terminal will be specifically introduced with reference to FIG. 1.

The radio frequency unit 101 can be used for transmitting and receiving signals during the process of transceiving information or talking. Specifically, after receiving the downlink information of the base station, the downlink information is processed by the processor 110; in addition, the uplink data is sent to the base station. Generally, the radio frequency unit 101 includes, but is not limited to, an antenna, at least one amplifier, a transceiver, a coupler, a low noise amplifier, a duplexer, and the like. In addition, the radio frequency unit 101 can also communicate with the network and other devices through wireless communication. The above-mentioned wireless communication can use any communication standard or protocol, including but not limited to Global System of Mobile communication (GSM), General Packet Radio Service (GPRS), Code Division Multiple Access 2000 (CDMA2000), Wideband Code Division Multiple Access (WCDMA), Time Division-Synchronous Code Division Multiple Access (TD-SCDMA), Frequency Division Duplexing-Long Term Evolution (FDD-LTE), Time Division Duplexing-Long Term Evolution (TDD-LTE), and 5G and 6G, or the like.

Wi-Fi is a short-range wireless transmission technology. The mobile terminal can help users transmit and receive email, browse webpage, and access streaming media through the Wi-Fi module 102, and Wi-Fi provides users with wireless broadband Internet access. Although FIG. 1 shows the Wi-Fi module 102, it is understandable that it is not a necessary component of the mobile terminal and can be omitted as needed without changing the essence of the present application.

When the mobile terminal 100 is in a call signal receiving mode, a call mode, a recording mode, a voice recognition mode, a broadcast receiving mode, or the like, the audio output unit 103 can convert the audio data received by the radio frequency unit 101 or the Wi-Fi module 102 or stored in the memory 109 into an audio signal and output the audio signal as sound. Moreover, the audio output unit 103 can further provide audio output related to a specific function performed by the mobile terminal 100 (for example, call signal reception sound, message reception sound, or the like). The audio output unit 103 can include a speaker, a buzzer, or the like.

The A/V input unit 104 is configured to receive audio or video signals. The A/V input unit 104 can include a graphics processing unit (GPU) 1041 and a microphone 1042. The graphics processing unit 1041 processes image data of still pictures or videos obtained by an image capture device (such as a camera) in a video capture mode or an image capture mode. The processed image frame can be displayed on the display unit 106. The image frame processed by the graphics processing unit 1041 can be stored in the memory 109 (or other storage medium) or sent via the radio frequency unit 101 or the Wi-Fi module 102. The microphone 1042 can receive sound (audio data) in operation modes such as a call mode, a recording mode, a voice recognition mode, and the like, and can process such sound into audio data. The processed audio (voice) data can be converted into a format that can be sent to a mobile communication base station via the radio frequency unit 101 in the case of a call mode for output. The microphone 1042 can implement various types of noise cancellation (or suppression) algorithms to eliminate (or suppress) noise or interference generated during the process of transceiving audio signals.

The mobile terminal 100 also includes at least one sensor 105, such as a light sensor, a motion sensor, and other sensors. Specifically, the light sensor includes an ambient light sensor and a proximity sensor. The ambient light sensor can adjust the brightness of the display panel 1061 according to the brightness of the ambient light. The proximity sensor can turn off the display panel 1061 and/or the backlight when the mobile terminal 100 is moved to the ear. A gravity acceleration sensor, as a kind of motion sensor, can detect the magnitude of acceleration in various directions (usually three axes). The gravity acceleration sensor can detect the magnitude and direction of gravity when it is stationary, and can identify the gesture of the mobile terminal (such as horizontal and vertical screen switch, related games, magnetometer attitude calibration), vibration recognition related functions (such as pedometer, tap), or the like. The mobile terminal can also be equipped with other sensors such as a fingerprint sensor, a pressure sensor, an iris sensor, a molecular sensor, a gyroscope, a barometer, a hygrometer, a thermometer, an infrared sensor and other sensors, which will not be repeated herein.

The display unit 106 is configured to display information input by the user or information provided to the user. The display unit 106 can include a display panel 1061, and the display panel 1061 can be configured in the form of a liquid crystal display (LCD), an organic light emitting diode (OLED), or the like.

The user input unit 107 can be configured to receive inputted numeric or character information, and generate key signal input related to user settings and function control of the mobile terminal. Specifically, the user input unit 107 can include a touch panel 1071 and other input devices 1072. The touch panel 1071, also called a touch screen, can collect user touch operations on or near it (for example, the user uses fingers, stylus and other suitable objects or accessories to operate on the touch panel 1071 or near the touch panel 1071), and drive the corresponding connection device according to a preset program. The touch panel 1071 can include two parts: a touch detection device and a touch controller. The touch detection device detects the user's touch position, detects the signal brought by the touch operation, and transmits the signal to the touch controller. The touch controller receives the touch information from the touch detection device, converts the touch information into contact coordinates, and transmits it to the processor 110, and can receive and execute the instructions sent by the processor 110. In addition, the touch panel 1071 can be implemented in multiple types such as resistive, capacitive, infrared, and surface acoustic wave. In addition to the touch panel 1071, the user input unit 107 can also include other input devices 1072. Specifically, the other input devices 1072 can include, but are not limited to, one or more of physical keyboard, function keys (such as volume control buttons, switch buttons, etc.), trackball, mouse, joystick, etc., which are not specifically limited here.

Optionally, the touch panel 1071 can cover the display panel 1061. After the touch panel 1071 detects a touch operation on or near it, the touch operation is transmitted to the processor 110 to determine the type of the touch event, and then the processor 110 provides a corresponding visual output on the display panel 1061 according to the type of the touch event. Although in FIG. 1, the touch panel 1071 and the display panel 1061 are used as two independent components to realize the input and output functions of the mobile terminal, in some embodiments, the touch panel 1071 and the display panel 1061 can be integrated to implement the input and output functions of the mobile terminal, which is not specifically limited here.

The interface unit 108 serves as an interface through which at least one external device can be connected to the mobile terminal 100. For example, the external device can include a wired or wireless earphone port, an external power source (or battery charger) port, a wired or wireless data port, a memory card port, a port for connecting devices with identification modules, an audio input/output (I/O) port, a video I/O port, an earphone port, or the like. The interface unit 108 can be configured to receive input (such as data information, electricity, or the like) from an external device and transmit the received input to one or more elements in the mobile terminal 100 or can be configured to transfer data between the mobile terminal 100 and the external device.

The memory 109 can be configured to store software programs and various data. The memory 109 can mainly include a program storage area and a data storage area. The program storage area can store the operating system, at least one application required by the function (such as sound play function, image play function, etc.), or the like. The data storage area can store data (such as audio data, phone book, etc.) created based on the use of the mobile phone. In addition, the memory 109 can include a high-speed random access memory, and can also include a non-volatile memory, such as at least one magnetic disk storage device, a flash memory device, or other volatile solid-state storage devices.

The processor 110 is a control center of the mobile terminal, and uses various interfaces and lines to connect the various parts of the entire mobile terminal. By running or performing the software programs and/or modules stored in the memory 109, and calling the data stored in the memory 109, various functions and processing data of the mobile terminal are executed, thereby overall monitoring of the mobile terminal is performed. The processor 110 can include one or more processing units; and the processor 110 may integrate an application processor and a modem processor. The application processor mainly processes an operating system, a user interface, an application, or the like, and the modem processor mainly processes wireless communication. It can be understood that the foregoing modem processor may not be integrated into the processor 110.

The mobile terminal 100 can also include a power source 111 (such as a battery) for supplying power to various components. The power supply 111 can be logically connected to the processor 110 through a power management system, so that functions such as charging, discharging, and power consumption management can be managed through the power management system.

Although not shown in FIG. 1, the mobile terminal 100 can also include a Bluetooth module, or the like, which will not be repeated herein.

In order to facilitate the understanding of the embodiments of the present application, the following describes the communication network system on which the mobile terminal of the present application is based.

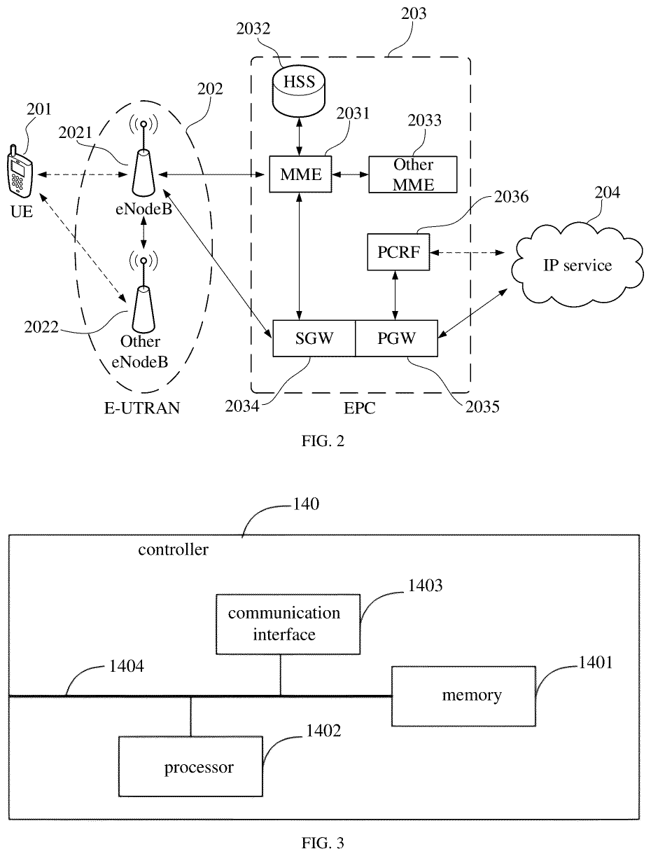

As shown in FIG. 2, FIG. 2 is an architecture diagram of a communication network system according to an embodiment of the present application. The communication network system is an LTE system of general mobile communication network technology. The LTE system includes a User Equipment (UE) 201, an Evolved UMTS Terrestrial Radio Access Network (E-UTRAN) 202, an Evolved Packet Core (EPC) 203, and an operator's IP service 204 that are sequentially connected in communication.

Optionally, the UE 201 can be the aforementioned terminal 100, which will not be repeated here.

E-UTRAN 202 includes eNodeB 2021 and other eNodeBs 2022. The eNodeB 2021 can be connected to other eNodeBs 2022 through a backhaul (for example, an X2 interface), the eNodeB 2021 is connected to the EPC 203, and the eNodeB 2021 can provide access from the UE 201 to the EPC 203.

The EPC 203 can include Mobility Management Entity (MME) 2031, Home Subscriber Server (HSS) 2032, other MMEs 2033, Serving Gate Way (SGW) 2034, PDN Gate Way (PGW) 2035, Policy and Charging Rules Function (PCRF) 2036, and so on. MME 2031 is a control node that processes signaling between UE 201 and EPC 203, and provides bearer and connection management. HSS 2032 is configured to provide some registers to manage functions such as the home location register (not shown), and save some user-specific information about service feature, data rates, and so on. All user data can be sent through SGW 2034, PGW 2035 can provide UE 201 IP address allocation and other functions. PCRF 2036 is a policy and charging control policy decision point for service data flows and IP bearer resources, which selects and provides available policy and charging control decisions for policy and charging execution functional units (not shown).

The IP service 204 can include Internet, intranet, IP Multimedia Subsystem (IMS), or other IP services.

Although the LTE system is described above as an example, those skilled in the art should know that, the present application is not only applicable to the LTE system, but also applicable to other wireless communication systems, such as GSM, CDMA2000, WCDMA, TD-SCDMA, 5G and new network systems in the future (such as 6G), or the like, which is not limited herein.

Based on the above-mentioned mobile terminal hardware structure and communication network system, various embodiments of the present application are provided.

FIG. 3 is a schematic diagram of the hardware structure of a controller 140 provided in the present application. The controller 140 includes a memory 1401 and a processor 1402, the memory 1401 is configured to store program instructions, and the processor 1402 is configured to call the program instructions in the memory 1401 to execute the steps performed by the controller in the first embodiment of the above-mentioned method. The implementation principle and beneficial effects are similar and will not be repeated here.

Optionally, the above-mentioned controller also includes a communication interface 1403, which can be connected to the processor 1402 through a bus 1404. The processor 1402 can control the communication interface 1403 to realize the receiving and transmitting functions of the controller 140.

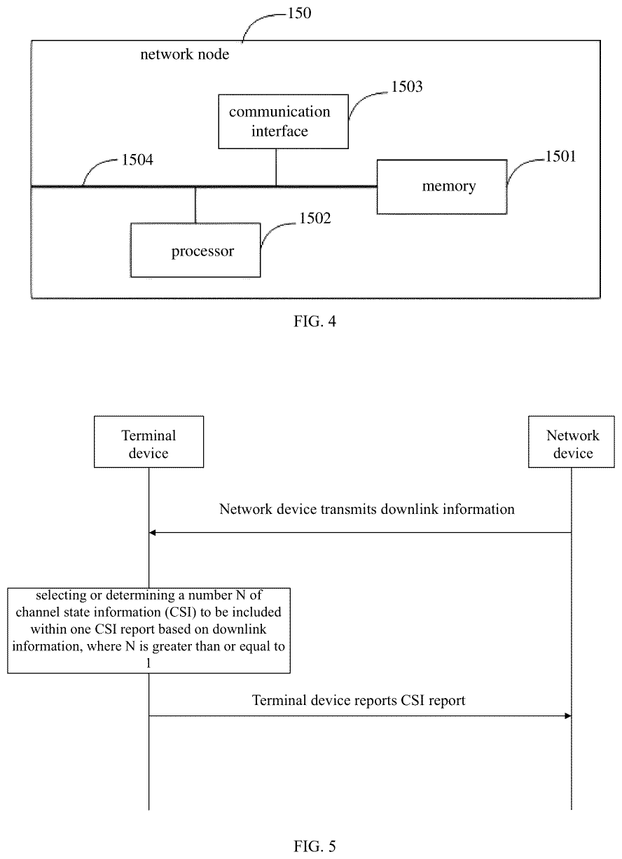

FIG. 4 is a schematic diagram of the hardware structure of a network node 150 provided in the present application. The network node 150 includes a memory 1501 and a processor 1502. The memory 1501 is configured to store program instructions, and the processor 1502 is configured to call the program instructions in the memory 1501 to execute the steps performed by the first node in the first embodiment of the above method. The implementation principle and beneficial effects are similar and will not be repeated here.

Optionally, the above controller also includes a communication interface 1503, which can be connected to the processor 1502 through a bus 1504. The processor 1502 can control the communication interface 1503 to implement the receiving and transmitting functions of the network node 150.

The above-mentioned integrated module implemented in the form of a software function module can be stored in a computer-readable storage medium. The above-mentioned software function module is stored in a storage medium, including several instructions for enabling a computer device (which can be a personal computer, a server, or a network device, etc.) or a processor to perform some steps of the methods of various embodiments of the present application.

Technical terms involved in this embodiment are as follows.
CSI: Channel State Information;
CSI Report: Channel State Information Report;
CSI-RS: Channel State Information-Reference Signal;
PUCCH: Physical Uplink Control CHannel;
PUSCH: Physical Uplink Shared CHannel;
UCI bit: Uplink Control Information bit, which can be carried by PUCCH or PUSCH;
CQI: channel quality indicator;
RI: rank indicator;
PDSCH: Physical Downlink Shared CHannel.

The embodiments of the present application, it is considered that in existing protocols, a network device (for example, a base station) transmits a channel state information-reference signal (CSI-RS) to a terminal device (for example, a mobile phone). The terminal device measures the CSI-RS and reports a channel state information (CSI) report to the network device. The network device determines transmission parameters of a physical downlink shared channel, such as a precoding matrix and a rank, according to the CSI report. And/or, the terminal device can only report one CSI report corresponding to one antenna port number. When it is necessary to report multiple CSIs corresponding to multiple antenna port numbers, multiple CSIs reports corresponding to the multiple antenna port numbers need to be reported at different times, which may result in excessive CSI reporting and/or CSI expiration.

Based on this, the solution provided in the embodiments of the present application can solve the problem that if multiple CSIs of multiple antenna port numbers need to be reported, the multiple CSIs reports corresponding to the multiple antenna port numbers need to be reported at different times, which may result in excessive CSI reporting and/or CSI expiration, thereby achieving the purpose of reducing the number of CSI reports and/or ensuring the timeliness of CSI.

### First Embodiment

As shown in FIG. 5, the first embodiment of the present application provides a processing method, including:
a network device transmitting downlink information so that a terminal device selects or determines a number N of CSIs to be included within one CSI report based on the downlink information, where N is greater than or equal to 1.

The terminal device selects or determines the number N of CSIs to be included within the CSI report based on the downlink information, where N is greater than or equal to 1.

The terminal device reports the CSI report.

Optionally, the downlink information includes at least one of the following:
downlink control information;
radio resource control information; and
media access control information.

Optionally, the number N of CSI to be included within one CSI report is determined by at least one of the following:
determining N according to an indication field in the downlink control information that
specifies a preferred number of channel state information;
determining N according to an antenna port numbers to be measured configured by the downlink information; and
determining N according to terminal device capabilities and service requirements.

Optionally, N is less than or equal to the antenna port numbers to be measured configured by the downlink information.

Optionally, a CSI Report includes at least one of the following:
information of antenna port number indicator, where the antenna port number indicator indicates N different antenna port numbers corresponding respectively to the N CSIs; and
the N CSIs corresponding respectively to N different antenna port numbers, where at least one CSI in the N CSIs includes a wideband channel quality indicator and/or a rank indicator.

Optionally, the antenna port number indicator includes at least one of the following:
a CSI-RS resource identifier field corresponding to N different antenna port numbers;
a CSI-RS resource set identifier field corresponding to N different antenna port numbers;
a logical index number field of a CSI-RS resource identifier corresponding to N different antenna port numbers;
a logical index number field of a CSI-RS resource set identifier corresponding to N different antenna port numbers; and
an index position field of N different antenna port numbers in a resource pool.

Optionally, the terminal device selects or determines a number N of CSIs to be included within one CSI report based on a number indication field of preferred CSI in downlink control information, where N is greater than or equal to 1.

Optionally, an indication field in the downlink control information that specifies a preferred number of channel state information is newly added in downlink control information. Optionally, the indication field in the downlink control information that specifies a preferred number of channel state information occupies 3 bits. Optionally, bits 000 indicate that one channel state information corresponding to the best antenna port number needs to be reported, bits 001 indicate that two channel state information corresponding to the best antenna port numbers need to be reported, bits 010 indicate that three channel state information corresponding to the best antenna port numbers need to be reported, and bits 111 indicate that eight channel state information corresponding to the best antenna port numbers need to be reported. If the indication field in the downlink control information that specifies a preferred number of channel state information is set to bit value 011, and the antenna port numbers to be measured determined according to the downlink control information, radio resource control information, and/or media access control information includes: 32 ports, 16 ports, 12 ports, 8 ports, 4 ports, and 2 ports, the terminal device first obtains time-frequency domain resources of non-zero power CSI-RS corresponding to each of the six antenna port numbers to be measured according to the downlink control information, radio resource control information, and/or media access control information, and measures the non-zero power CSI-RS corresponding to each antenna port number, thereby obtaining channel reception quality corresponding to each antenna port number. The terminal device then ranks the channel reception quality corresponding to each antenna port number. Optionally, since the indication field in the downlink control information that specifies a preferred number of channel state information is set to bit value 011, a number N of CSIs that need to be included within one CSI report is 3. The terminal device then reports, to the network device, the antenna port number indicators corresponding to the top three antenna port numbers with the best channel reception quality, together with a wideband channel quality indicator and/or a rank indicator corresponding to at least one of the top three antenna port numbers.

In the technical solution of this embodiment: The network device transmits downlink control information. The terminal device selects or determines a number N of CSIs that need to be included within one CSI report the indication field in the downlink control information that specifies a preferred number of channel state information. The terminal device then determines channel reception quality corresponding to each antenna port number to be measured, and reports, to the network device, the antenna port number indicators corresponding to the N antenna port numbers with the best channel reception quality, together with a wideband channel quality indicator and/or a rank indicator corresponding to at least one of the N antenna port numbers with the best channel reception quality, so as to achieve the purpose of reducing the number of CSI reports and/or ensuring the timeliness of CSI. Optionally, by indicating, through the downlink control information, a number N of CSIs that need to be included within one CSI report, the terminal device does not need to include all CSIs corresponding to all antenna port numbers to be measured within one CSI report. Therefore, the technical solution of this embodiment can reduce the number of CSIs to be included within one CSI report, thereby reducing the reporting overhead of the CSI report. Optionally, by including antenna port number indicators in the CSI report, the technical solution of this embodiment can also help the network device quickly identify specific antenna port numbers corresponding to multiple CSI results in the current CSI report, thereby facilitating the network device in determining transmission parameters for physical downlink shared channel transmission, such as the number of antenna ports available for PDSCH transmission.

### Second Embodiment

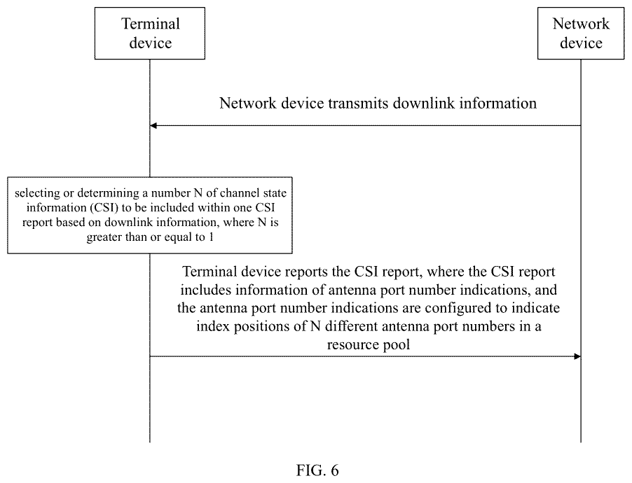

As shown in FIG. 6, based on any of the above embodiments, a second embodiment of the present application is provided, including:

The network device transmits downlink information so that the terminal device selects or determines a number N of CSIs to be included within one CSI report based on the downlink information, where N is greater than or equal to 1.

The terminal device selects or determines a number N of CSIs to be included within one CSI report based on the downlink information.

The terminal device reports the CSI report.

Optionally, the downlink information includes at least one of the following:
downlink control information;
radio resource control information; and
media access control information.

Optionally, the number N of CSI to be included within one CSI report is determined by at least one of the following:
determining N according to an indication field in the downlink control information that specifies a preferred number of channel state information;
determining N according to an antenna port numbers to be measured configured by the downlink information; and
determining N according to terminal device capabilities and service requirements.

Optionally, N is less than or equal to the antenna port numbers to be measured configured by the downlink information.

Optionally, a CSI Report includes at least one of the following:
information of antenna port number indicator, where the antenna port number indicator indicates N different antenna port numbers corresponding respectively to the N CSIs; and
the N CSIs corresponding respectively to N different antenna port numbers, where at least one CSI in the N CSIs includes a wideband channel quality indicator and/or a rank indicator.

Optionally, the antenna port number indicator includes at least one of the following:
a CSI-RS resource identifier field corresponding to N different antenna port numbers;
a CSI-RS resource set identifier field corresponding to N different antenna port numbers;
a logical index number field of a CSI-RS resource identifier corresponding to N different antenna port numbers;
a logical index number field of a CSI-RS resource set identifier corresponding to N different antenna port numbers; and
an index position field of N different antenna port numbers in a resource pool.

Optionally, the terminal device selects or determines a number N of CSIs to be included within one CSI report based on an indication field in the downlink control information that specifies a preferred number of channel state information in downlink control information, where N is greater than or equal to 1.

Optionally, the terminal device reports the CSI report, where the CSI report includes information of antenna port number indicator, the antenna port number indicator being configured to indicate index positions of N different antenna port numbers in a resource pool.

Optionally, in this embodiment, CSI-RS corresponding to different antenna port numbers have the same non-zero power CSI-RS resource identifier.

Optionally, an indication field in the downlink control information that specifies a preferred number of channel state information is newly added in downlink control information. Optionally, the indication field in the downlink control information that specifies a preferred number of channel state information occupies 3 bits. Optionally, bits 000 indicate that one channel state information corresponding to the best antenna port number needs to be reported, bits 001 indicate that two channel state information corresponding to the best antenna port numbers need to be reported, bits 010 indicate that three channel state information corresponding to the best antenna port numbers need to be reported, and bits 111 indicate that eight channel state information corresponding to the best antenna port numbers need to be reported.

Optionally, if the indication field in the downlink control information that specifies a preferred number of channel state information is set to bit value 011, and the antenna port numbers to be measured indicated in the downlink control information, radio resource control information, and/or media access control information includes 32 ports, 16 ports, 12 ports, 8 ports, 4 ports, and 2 ports, the terminal device first obtains time-frequency domain resources of non-zero power CSI-RS corresponding to each of the six antenna port numbers to be measured according to the downlink information, including the downlink control information, radio resource control information, and/or media access control information, and measures the non-zero power CSI-RS corresponding to each antenna port number, thereby obtaining channel reception quality corresponding to each antenna port number. The terminal device then ranks the channel reception quality of each antenna port number in descending order. For example, when the ranking results of the antenna port numbers corresponding to the channel reception quality from highest to lowest are 16 ports, 8 ports, 4 ports, 2 ports, 12 ports, and 32 ports, and since the indication field in the downlink control information that specifies a preferred number of channel state information is set to bit value 011, the number N of CSIs that need to be included within one CSI report is 3. That is, the three CSIs to be reported corresponding respectively to antenna port numbers 16 ports, 8 ports, and 4 ports.

Optionally, the number of bits occupied by the antenna port number indicators to be included within one CSI report is 8. Optionally, each bit respectively represents a different antenna port number. Optionally, each bit sequentially corresponds to each antenna port number in the set {32 ports, 24 ports, 16 ports, 12 ports, 8 ports, 4 ports, 2 ports, 1 port}. For example, the leftmost highest bit corresponds to 32 ports, the second bit from the left corresponds to 24 ports, and so on. When the antenna port numbers for which CSI needs to be reported are {16 ports, 8 ports, 4 ports}, the bit value of the antenna port number indicators to be included within one CSI report is 00101100.

Optionally, one CSI report further includes N CSIs corresponding to N different antenna port numbers. Therefore, in the above embodiment, one CSI report further needs to include CSIs corresponding to the top N=3 antenna port numbers {16 ports, 8 ports, 4 ports} with the best channel quality, and at least one CSI among the N=3 CSIs includes a wideband channel quality indicator and/or a rank indicator.

In the technical solution of this embodiment: the network device transmits downlink control information. The terminal device selects or determines a number N of CSIs to be included within one CSI report based on the indication field in the downlink control information that specifies a preferred number of channel state information. The terminal device then determines channel reception quality corresponding to each antenna port number to be measured, and combines antenna port number indicators corresponding to the N antenna port numbers with the best channel reception quality, with a wideband channel quality indicator or a rank indicator corresponding to at least one of the N antenna port numbers with the best channel reception quality, so as to form different bits within the UCI bit set, and reports them to the network device through one CSI report, so as to achieve the purpose of reducing the number of CSI reports and/or ensuring the timeliness of CSI. Meanwhile, according to the antenna port number indicators, the terminal device determines antenna port numbers corresponding respectively to the reported N CSIs, thereby allowing the network device to quickly identify values of antenna port numbers corresponding to multiple CSI results in the current CSI report, and facilitating the network device in determining transmission parameters for physical downlink shared channel transmission, such as the number of antenna ports available for PDSCH transmission.

### Third Embodiment

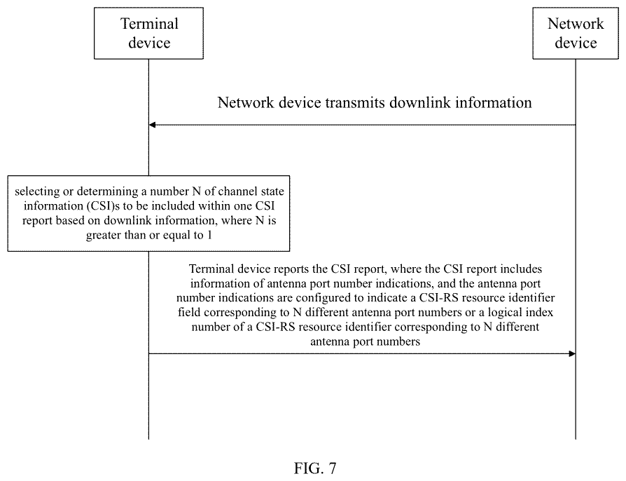

As shown in FIG. 7, based on any of the above embodiments, a third embodiment of the present application is provided, including:
the network device transmits downlink information so that the terminal device selects or determines a number N of channel state information (CSI) s to be included within one CSI report based on the downlink information, where N is greater than or equal to 1.

The terminal device selects or determines the number N of CSIs to be included within the CSI report based on the downlink information.

The terminal device reports the CSI report.

Optionally, the downlink information includes at least one of the following:
downlink control information;
radio resource control information; and
media access control information.

Optionally, the number N of CSI to be included within one CSI report is determined by at least one of the following:
determining N according to an indication field in the downlink control information that specifies a preferred number of channel state information;
determining N according to an antenna port numbers to be measured configured by the downlink information; and
determining N according to terminal device capabilities and service requirements.

Optionally, N is less than or equal to the antenna port numbers to be measured configured by the downlink information.

Optionally, a CSI Report includes at least one of the following:
information of antenna port number indicator, where the antenna port number indicator indicates N different antenna port numbers corresponding respectively to the N CSIs; and
the N CSIs corresponding respectively to N different antenna port numbers, where at least one CSI in the N CSIs includes a wideband channel quality indicator and/or a rank indicator.

Optionally, the antenna port number indicator includes at least one of the following:
a CSI-RS resource identifier field corresponding to N different antenna port numbers;
a CSI-RS resource set identifier field corresponding to N different antenna port numbers;
a logical index number field of a CSI-RS resource identifier corresponding to N different antenna port numbers;
a logical index number field of a CSI-RS resource set identifier corresponding to N different antenna port numbers; and
an index position field of N different antenna port numbers in a resource pool.

Optionally, the terminal device selects or determines the number N of CSI to be included within one CSI report based on the indication field in the downlink control information that specifies a preferred number of channel state information, where N is greater than or equal to 1.

Optionally, the terminal device reports the CSI report, where the CSI report includes information of antenna port number indicator, the antenna port number indicator being configured to indicate a CSI-RS resource identifier field corresponding to N different antenna port numbers or a logical index number of a CSI-RS resource identifier corresponding to N different antenna port numbers.

Optionally, in this embodiment, CSI-RS corresponding to different antenna port numbers have different non-zero power CSI-RS resource identifiers.

Optionally, an indication field in the downlink control information that specifies a preferred number of channel state information is newly added in downlink control information. Optionally, the indication field in the downlink control information that specifies a preferred number of channel state information occupies 3 bits. Optionally, bits 000 indicate that one channel state information corresponding to the best antenna port number needs to be reported, bits 001 indicate that two channel state information corresponding to the best antenna port numbers need to be reported, bits 010 indicate that three channel state information corresponding to the best antenna port numbers need to be reported, and bits 111 indicate that eight channel state information corresponding to the best antenna port numbers need to be reported.

If the indication field in the downlink control information that specifies a preferred number of channel state information is set to bit value 011, and the antenna port numbers to be measured indicated in the downlink control information, radio resource control information, and/or media access control information includes 32 ports, 16 ports, 12 ports, 8 ports, 4 ports, and 2 ports, the terminal device first obtains time-frequency domain resources of non-zero power CSI-RS corresponding to each of the six antenna port numbers to be measured according to the downlink information, including the downlink control information, radio resource control information, and/or media access control information, and measures the non-zero power CSI-RS corresponding to each antenna port number, thereby obtaining channel reception quality corresponding to each antenna port number. The terminal device then ranks the channel reception quality of each antenna port number in descending order. For example, when the ranking results of antenna port numbers corresponding to the channel reception quality from highest to lowest are 16 ports, 8 ports, 4 ports, 2 ports, 12 ports, and 32 ports, and since the indication field in the downlink control information that specifies a preferred number of channel state information is set to bit value 011, the number N of CSIs that need to be included within one CSI report is 3. That is, the three CSIs to be reported corresponding respectively to antenna port numbers 16 ports, 8 ports, and 4 ports.

Optionally, the number of bits occupied by the antenna port number indicators to be included within one CSI report is 64. Optionally, the bits of the antenna port number indicators from highest to lowest corresponding respectively to non-zero power CSI-RS resource identifiers 0 to 63. When the three antenna port numbers for which CSI needs to be reported, namely 16 ports, 8 ports, and 4 ports, corresponding respectively to non-zero power CSI-RS resource identifiers 1, 3, and 60, the terminal device determines that the bit value of the antenna port number indicators in the CSI report used for reporting antenna port numbers is 0101 0000 0000 0000 0000 0000 0000 0000 0000 0000 0000 0000 0000 0000 0000 1000.

Optionally, the antenna port number indicators may be logical index numbers related to a set of antenna port numbers to be measured and/or CSI-RS resource identifiers corresponding to the antenna port numbers to be measured, satisfying a first preset rule.

Optionally, satisfying the first preset rule includes at least one of the following:
determining logical index numbers of the antenna port numbers to be measured, according to the antenna port numbers to be measured, sorted in descending order;
determining logical index numbers of the antenna port numbers to be measured, according to the antenna port numbers to be measured, sorted in ascending order;
determining logical index numbers of the antenna port numbers to be measured, according to CSI-RS resource identifiers corresponding to the antenna port numbers to be measured, sorted in ascending order; and
determining logical index numbers of the antenna port numbers to be measured, according to CSI-RS resource identifiers corresponding to the antenna port numbers to be measured, sorted in descending order.

Optionally, satisfying the first preset rule is to determine logical index numbers of the antenna port numbers to be measured according to the antenna port numbers to be measured sorted in descending order. Logical index numbers of the antenna port numbers to be measured determined according to the first preset rule are shown in Table 1.

TABLE 1

| Logical index | Non-zero power channel state information | Antenna port |
|---|---|---|
| number | reference signal resource identifier | number |
| 0 | 5 | 32 |
| 1 | 0 | 24 |
| 2 | 12 | 16 |
| 3 | 10 | 12 |
| 4 | 8 | 8 |
| 5 | 28 | 4 |
| 6 | 16 | 2 |
| 7 | 25 | 1 |

Optionally, the number of bits occupied by the antenna port number indicators to be included within one CSI report is 8, and the bits of the antenna port number indicators from highest to lowest corresponding respectively to logical index numbers 0 to 7 in the logical index number column of the above table. Optionally, satisfying the first preset rule is to determine logical index numbers of the antenna port numbers to be measured according to the antenna port numbers to be measured sorted in descending order. According to Table 1, the leftmost highest bit in the antenna port number indicators corresponds to logical index number 0, that is, an antenna port number of 32; the second bit from the left corresponds to logical index number 1, that is, an antenna port number of 24, and so on. Therefore, when CSI-RS corresponding to different antenna port numbers have different non-zero power CSI-RS resource identifiers, and the three antenna port numbers that the terminal device needs to report are 16 ports, 8 ports, and 4 ports, the antenna port number indicators to be included within one CSI report are bits 00101100.

Optionally, satisfying the first preset rule is to determine logical index numbers of the antenna port numbers to be measured according to the antenna port numbers to be measured sorted in ascending order. Logical index numbers of the antenna port numbers to be measured determined according to the first preset rule are shown in Table 2.

TABLE 2

| Logical index | Non-zero power channel state information | Antenna port |
|---|---|---|
| number | reference signal resource identifier | number |
| 0 | 25 | 1 |
| 1 | 16 | 2 |
| 2 | 28 | 4 |
| 3 | 8 | 8 |
| 4 | 10 | 12 |
| 5 | 12 | 16 |
| 6 | 0 | 24 |
| 7 | 5 | 32 |

The number of bits occupied by the antenna port number indicators to be included within one CSI report is 8, and the bits of the antenna port number indicators from highest to lowest corresponding respectively to logical index numbers 0 to 7 in the logical index number column of the above table. Satisfying the first preset rule is to determine logical index numbers of the antenna port numbers to be measured according to the antenna port numbers to be measured sorted in ascending order. According to Table 2, the leftmost highest bit in the antenna port number indicators corresponds to logical index number 0, that is, an antenna port number of 1; the second bit from the left corresponds to logical index number 1, that is, an antenna port number of 2, and so on. Therefore, when CSI-RS corresponding to different antenna port numbers have different non-zero power CSI-RS resource identifiers, and the three antenna port numbers that the terminal device needs to report are 16 ports, 8 ports, and 4 ports, the antenna port number indicators to be included within one CSI report are bits 00110100.

Optionally, satisfying the first preset rule is to determine logical index numbers of the antenna port numbers to be measured according to CSI-RS resource identifiers corresponding to the antenna port numbers to be measured sorted in ascending order. Logical index numbers of the antenna port numbers to be measured determined according to the first preset rule are shown in Table 3.

TABLE 3

| Logical index | Non-zero power channel state information | Antenna port |
|---|---|---|
| number | reference signal resource identifier | number |
| 0 | 0 | 24 |
| 1 | 5 | 32 |
| 2 | 8 | 8 |
| 3 | 10 | 12 |
| 4 | 12 | 16 |
| 5 | 16 | 2 |
| 6 | 25 | 1 |
| 7 | 28 | 4 |

The number of bits occupied by the antenna port number indicators to be included within one CSI report is 8, and the bits of the antenna port number indicators from highest to lowest corresponding respectively to logical index numbers 0 to 7 in the logical index number column of the above table. Satisfying the first preset rule is to determine logical index numbers of the antenna port numbers to be measured according to CSI-RS resource identifiers corresponding to the antenna port numbers to be measured sorted in ascending order. According to Table 3, the leftmost highest bit in the antenna port number indicators corresponds to logical index number 0, that is, a non-zero power CSI-RS resource identifier 0; the second bit from the left corresponds to logical index number 1, that is, a non-zero power CSI-RS resource identifier 5, and so on. Therefore, when CSI-RS corresponding to different antenna port numbers have different non-zero power CSI-RS resource identifiers, and the three antenna port numbers that the terminal device needs to report, 16 ports, 8 ports, and 4 ports, corresponding respectively to non-zero power CSI-RS resource identifiers 12, 8, and 28, the antenna port number indicators to be included within one CSI report are bits 00101001.

Optionally, satisfying the first preset rule is to determine logical index numbers of the antenna port numbers to be measured according to CSI-RS resource identifiers corresponding to the antenna port numbers to be measured sorted in descending order. Logical index numbers of the antenna port numbers to be measured determined according to the first preset rule are shown in Table 4.

TABLE 4

| Logical index | Non-zero power channel state information | Antenna port |
|---|---|---|
| number | reference signal resource identifier | number |
| 0 | 28 | 4 |
| 1 | 25 | 1 |
| 2 | 16 | 2 |
| 3 | 12 | 16 |
| 4 | 10 | 12 |
| 5 | 8 | 8 |
| 6 | 5 | 32 |
| 7 | 0 | 24 |

The number of bits occupied by the antenna port number indicators to be included within one CSI report is 8, and the bits of the antenna port number indicators from highest to lowest corresponding respectively to logical index numbers 0 to 7 in the logical index number column of the above table. Satisfying the first preset rule is to determine logical index numbers of the antenna port numbers to be measured according to CSI-RS resource identifiers corresponding to the antenna port numbers to be measured sorted in descending order. According to Table 4, the leftmost highest bit in the antenna port number indicators corresponds to logical index number 0, that is, a non-zero power CSI-RS resource identifier 28; the second bit from the left corresponds to logical index number 1, that is, a non-zero power CSI-RS resource identifier 25, and so on. Therefore, when CSI-RS corresponding to different antenna port numbers have different non-zero power CSI-RS resource identifiers, and the three antenna port numbers that the terminal device needs to report, 16 ports, 8 ports, and 4 ports, corresponding respectively to non-zero power CSI-RS resource identifiers 12, 8, and 28, the antenna port number indicators to be included within one CSI report are bits 10010100.

Optionally, the non-zero power CSI-RS resource identifiers corresponding to the antenna port numbers in Tables 1 to 4 are provided only as examples, and the non-zero power CSI-RS resource identifiers corresponding to the antenna port numbers shall be determined based on the configuration provided by the radio resource control information in the system.

Optionally, the antenna port number indicators may be logical index numbers of N antenna port numbers that satisfy the first preset rule.

Optionally, one CSI report further includes N CSIs corresponding respectively to N different antenna port numbers. The terminal device reports, in the same CSI Report, the bits formed by a wideband channel quality indicator and/or a rank indicator corresponding to at least one of the top-N sorted antenna port numbers together with the bits of the antenna port number indicators, to the network device.

In the technical solution of this embodiment: the network device transmits downlink control information, and the terminal device selects or determines a number N of CSIs to be included within one CSI report based on an indication field in the downlink control information that specifies a preferred number of channel state information. The terminal device determines the channel reception quality of each antenna port number to be measured, and generates UCI bits composed of antenna port number indicators corresponding to the top N antenna port numbers with the best channel reception quality, a wideband channel quality indicator or a rank indicator corresponding to at least one of the top N antenna port numbers, and the antenna port number indicators. The terminal device reports the UCI bits to the network device through one CSI report, so as to achieve the purpose of reducing CSI reporting frequency and/or ensuring CSI timeliness. In this embodiment, the technical solution effectively reduces the number of bits occupied by the antenna port number indicators by reporting logical index numbers of antenna port numbers, thereby further reducing the overhead of the CSI report. Meanwhile, based on the antenna port number indicators, the network device can determine the antenna port numbers corresponding respectively to the reported N CSIs, thereby quickly identifying the antenna port number values corresponding to multiple CSI results in the current CSI report, which facilitates determining transmission parameters of a PDSCH, such as the number of antenna ports available for PDSCH transmission.

### Fourth Embodiment

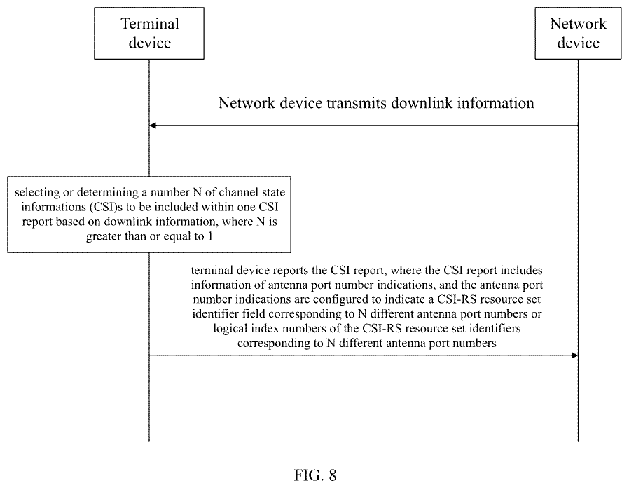

As shown in FIG. 8, based on any of the above embodiments, a fourth embodiment of the present application is provided, including:
the network device transmits downlink information so that the terminal device selects or determines a number N of CSIs to be included within one CSI report based on the downlink information, where N is greater than or equal to 1.

The terminal device selects or determines a number N of CSIs to be included within one CSI report based on the downlink information.

The terminal device reports the CSI report.

Optionally, the downlink information includes at least one of the following:
downlink control information;
radio resource control information; and
media access control information.

Optionally, the number N of CSI to be included within one CSI report is determined by at least one of the following:
determining N according to an indication field in the downlink control information that
specifies a preferred number of channel state information;
determining N according to an antenna port numbers to be measured configured by the downlink information; and
determining N according to terminal device capabilities and service requirements.

Optionally, N is less than or equal to the antenna port numbers to be measured configured by the downlink information.

Optionally, a CSI Report includes at least one of the following:
information of antenna port number indicator, where the antenna port number indicator indicates N different antenna port numbers corresponding respectively to the N CSIs; and
the N CSIs corresponding respectively to N different antenna port numbers, where at least one CSI in the N CSIs includes a wideband channel quality indicator and/or a rank indicator.

Optionally, the antenna port number indicator includes at least one of the following:
a CSI-RS resource identifier field corresponding to N different antenna port numbers;
a CSI-RS resource set identifier field corresponding to N different antenna port numbers;
a logical index number field of a CSI-RS resource identifier corresponding to N different antenna port numbers;
a logical index number field of a CSI-RS resource set identifier corresponding to N different antenna port numbers; and
an index position field of N different antenna port numbers in a resource pool.

Optionally, the terminal device selects or determines a number N of CSIs to be included within one CSI report based on an indication field in the downlink control information that specifies a preferred number of channel state information, where N is greater than or equal to 1.

Optionally, the terminal device reports the CSI report, where the CSI report includes information of antenna port number indicator, the antenna port number indicator being configured to indicate a CSI-RS resource set identifier field corresponding to N different antenna port numbers or logical index numbers of the CSI-RS resource set identifiers corresponding to N different antenna port numbers.

Optionally, in this embodiment, CSI-RS corresponding to different antenna port numbers have different non-zero power CSI-RS resource identifiers.

Optionally, an indication field in the downlink control information that specifies a preferred number of channel state information is newly added in the downlink control information. Optionally, the preferred channel state information number indication field occupies 3 bits. Optionally, bit 000 represents reporting one channel state information corresponding to the best antenna port number, bit 001 represents reporting two channel state information corresponding to the two best antenna port numbers, bit 010 represents reporting three channel state information corresponding to the three best antenna port numbers, and bit 111 represents reporting eight channel state information corresponding to the eight best antenna port numbers.

When the bit value of the indication field in the downlink control information that specifies a preferred number of channel state information is 011, and the number of antenna port numbers to be measured indicated in the downlink control information, radio resource control information, and/or media access control information is six, and the antenna port numbers to be measured include 32 ports, 16 ports, 12 ports, 8 ports, 4 ports, and 2 ports, the terminal device first obtains time-frequency domain resources of non-zero power CSI-RS corresponding to each of the six antenna port numbers to be measured based on the downlink control information, radio resource control information, and/or media access control information in the downlink information, and measures each non-zero power CSI-RS corresponding to the antenna port numbers to obtain channel reception quality corresponding to each antenna port number. The terminal device then sorts the channel reception qualities corresponding to the antenna port numbers in descending order. For example, the ranking results of the antenna port numbers corresponding to the channel reception quality from highest to lowest are 16 ports, 8 ports, 4 ports, 2 ports, 12 ports, and 32 ports. Since the bit value of the indication field in the downlink control information that specifies a preferred number of channel state information is 011, the number of CSIs to be included within one CSI report is three, that is, the three CSIs to be reported corresponding respectively to antenna port numbers 16 ports, 8 ports, and 4 ports.

Optionally, the number of bits occupied by antenna port number indicators to be included within one CSI report is 64. Optionally, the bits of the antenna port number indicators are arranged from highest to lowest, corresponding respectively to non-zero power CSI-RS resource set identifiers 0-63. The three antenna port numbers to be reported, 16 ports, 8 ports, and 4 ports, correspond to non-zero power CSI-RS resource set identifiers 1, 3, and 60 respectively. The terminal device determines that the UCI bits used in the CSI report to indicate the antenna port numbers corresponding to the reported antenna port numbers are 0101 0000 0000 0000 0000 0000 0000 0000 0000 0000 0000 0000 0000 0000 0000 1000.

Optionally, the antenna port number indicators may be logical index numbers related to the resource set identifiers of CSI-RS corresponding to the set of antenna port numbers to be measured and/or the antenna port numbers to be measured satisfying the first preset rule.

Optionally, satisfying the first preset rule includes at least one of the following:
determining logical index numbers of the antenna port numbers to be measured by sorting the antenna port numbers to be measured in descending order;
determining logical index numbers of the antenna port numbers to be measured by sorting the antenna port numbers to be measured in ascending order;
determining logical index numbers of the antenna port numbers to be measured by sorting the resource set identifiers of CSI-RS corresponding to the antenna port numbers to be measured in ascending order; and
determining logical index numbers of the antenna port numbers to be measured by sorting the resource set identifiers of the CSI-RS corresponding to the antenna port numbers to be measured in descending order.

Optionally, when the first preset rule is satisfied, the logical index numbers for the antenna ports to be measured are determined by sorting the number of antenna ports to be measured in descending order. The logical index numbers of the antenna port numbers to be measured determined according to the first preset rule are shown in Table 5.

TABLE 5

| Logical index | Non-zero power channel state information | Antenna port |
|---|---|---|
| number | reference signal resource set identifier | number |
| 0 | 5 | 32 |
| 1 | 0 | 24 |
| 2 | 12 | 16 |
| 3 | 10 | 12 |
| 4 | 8 | 8 |
| 5 | 28 | 4 |
| 6 | 16 | 2 |
| 7 | 25 | 1 |

In a CSI report, the antenna port number indicator occupies 8 bits. The bits of the antenna port number indicator from highest to lowest correspond to the logical index numbers 0-7 in the logical index column of the above table. When the first preset rule is satisfied by determining the logical index numbers of the antenna port numbers to be measured in descending order, it can be seen from Table 5 that the leftmost bit of the antenna port number indicator corresponds to the logical index number 0, that is, the antenna port number 32, and the second bit from the left corresponds to the logical index number 1, that is, the antenna port number 24, and so on. Therefore, when CSI-RS corresponding to different antenna port numbers have different non-zero power CSI-RS resource set identifiers, and the terminal device needs to report three antenna port numbers, namely 16 ports, 8 ports, and 4 ports, the antenna port number indicator within one CSI report is represented by the bits 00101100.

Optionally, the first preset rule is satisfied by determining the logical index numbers of the antenna port numbers to be measured according to an ascending order of the antenna port numbers to be measured. The logical index numbers of the antenna port numbers to be measured determined according to the first preset rule are shown in Table 6.

TABLE 6

| Logical index | Non-zero power channel state information | Antenna port |
|---|---|---|
| number | reference signal resource set identifier | number |
| 0 | 25 | 1 |
| 1 | 16 | 2 |
| 2 | 28 | 4 |
| 3 | 8 | 8 |
| 4 | 10 | 12 |
| 5 | 12 | 16 |
| 6 | 0 | 24 |
| 7 | 5 | 32 |

In a CSI report, the antenna port number indicator occupies 8 bits. The bits of the antenna port number indicator from highest to lowest correspond to the logical index numbers 0-7 in the logical index column of the above table. When the first preset rule is satisfied by determining the logical index numbers of the antenna port numbers to be measured in ascending order, it can be seen from Table 6 that the leftmost bit of the antenna port number indicator corresponds to the logical index number 0, that is, the antenna port number 1, and the second bit from the left corresponds to the logical index number 1, that is, the antenna port number 2, and so on. Therefore, when CSI-RS corresponding to different antenna port numbers have different non-zero power CSI-RS resource set identifiers, and the terminal device needs to report three antenna port numbers, namely 16 ports, 8 ports, and 4 ports, the antenna port number indicator within one CSI report is represented by the bits 00110100.

Optionally, the first preset rule is satisfied by determining the logical index numbers of the antenna port numbers to be measured according to an ascending order of the resource set identifiers of the CSI-RS corresponding to the antenna port numbers to be measured. The logical index numbers of the antenna port numbers to be measured determined according to the first preset rule are shown in Table 7.

TABLE 7

| Logical index | Non-zero power channel state information | Antenna port |
|---|---|---|
| number | reference signal resource set identifier | number |
| 0 | 0 | 24 |
| 1 | 5 | 32 |
| 2 | 8 | 8 |
| 3 | 10 | 12 |
| 4 | 12 | 16 |
| 5 | 16 | 2 |
| 6 | 25 | 1 |
| 7 | 28 | 4 |

In a CSI report, the antenna port number indicator occupies 8 bits. The bits of the antenna port number indicator from highest to lowest correspond to the logical index numbers 0-7 in the logical index column of the above table. When the first preset rule is satisfied by determining the logical index numbers of the antenna port numbers to be measured according to an ascending order of the resource set identifiers of the CSI-RS corresponding to the antenna port numbers to be measured, it can be seen from Table 7 that the leftmost bit of the antenna port number indicator corresponds to the logical index number 0, that is, the non-zero power CSI-RS resource set identifier 0, and the second bit from the left corresponds to the logical index number 1, that is, the non-zero power CSI-RS resource set identifier 5, and so on. Therefore, when CSI-RS corresponding to different antenna port numbers have different non-zero power CSI-RS resource set identifiers, and the terminal device needs to report three antenna port numbers, namely 16 ports, 8 ports, and 4 ports, which corresponding respectively to the non-zero power CSI-RS resource set identifiers 12, 8, and 28, the antenna port number indicator within one CSI report is represented by the bits 00101001.

Optionally, the first preset rule is satisfied by determining the logical index numbers of the antenna port numbers to be measured according to a descending order of the resource set identifiers of the CSI-RS corresponding to the antenna port numbers to be measured. The logical index numbers of the antenna port numbers to be measured determined according to the first preset rule are shown in Table 8.

TABLE 8

| Logical index | Non-zero power channel state information | Antenna port |
|---|---|---|
| number | reference signal resource set identifier | number |
| 0 | 28 | 4 |
| 1 | 25 | 1 |
| 2 | 16 | 2 |
| 3 | 12 | 16 |
| 4 | 10 | 12 |
| 5 | 8 | 8 |
| 6 | 5 | 32 |
| 7 | 0 | 24 |

In a CSI report, the antenna port number indicator occupies 8 bits. The bits of the antenna port number indicator from highest to lowest correspond to the logical index numbers 0-7 in the logical index column of the above table. When the first preset rule is satisfied by determining the logical index numbers of the antenna port numbers to be measured according to a descending order of the resource set identifiers of the CSI-RS corresponding to the antenna port numbers to be measured, it can be seen from Table 8 that the leftmost bit of the antenna port number indicator corresponds to the logical index number 0, that is, the non-zero power CSI-RS resource set identifier 28, and the second bit from the left corresponds to the logical index number 1, that is, the non-zero power CSI-RS resource set identifier 25, and so on. Therefore, when CSI-RS corresponding to different antenna port numbers have different non-zero power CSI-RS resource set identifiers, and the terminal device determines that the three antenna port numbers to be reported, namely 16 ports, 8 ports, and 4 ports, corresponding respectively to the non-zero power CSI-RS resource set identifiers 12, 8, and 28, the antenna port number indicator within one CSI report is represented by the bits 10010100.

Optionally, the non-zero power CSI-RS resource set identifiers corresponding to the antenna port numbers in Tables 5 to 8 are provided only as examples, and in practice, the non-zero-power CSI-RS resource set identifiers corresponding to the antenna port numbers shall be based on the configuration specified by the radio resource control information in the system.

Optionally, the antenna port number indicators may be logical index numbers of N antenna port numbers that satisfy the first preset rule. Optionally, one CSI report further includes N CSIs corresponding respectively to N different antenna port numbers. The terminal device reports, within one CSI report, the bits formed by a wideband channel quality indicator and/or a rank indicator corresponding to at least one of the top-N sorted antenna port numbers together with the bits of the antenna port number indicators, to the network device.

In the technical solution of this embodiment: the network device transmits downlink control information, and the terminal device selects or determines a number N of CSIs to be included within one CSI report, the indication field in the downlink control information that specifies a preferred number of channel state information. The terminal device determines the channel reception quality of each antenna port number to be measured, and generates UCI bits composed of antenna port number indicators corresponding to the top N antenna port numbers with the best channel reception quality, a wideband channel quality indicator or a rank indicator corresponding to at least one of the top N antenna port numbers, and the antenna port number indicators, and reports the UCI bits to the network device through one CSI report, so as to achieve the purpose of reducing CSI reporting frequency and/or ensuring CSI timeliness. In this embodiment, the technical solution effectively reduces the number of bits occupied by the antenna port number indicators by reporting logical index numbers of antenna port numbers, thereby further reducing the overhead of the CSI report. Meanwhile, based on the antenna port number indicators, the network device can determine the antenna port numbers corresponding respectively to the reported N CSIs, thereby quickly identifying the antenna port number values corresponding to multiple CSI results in the current CSI report, which facilitates determining transmission parameters of a PDSCH, such as the number of antenna ports available for PDSCH transmission.

### Fifth Embodiment

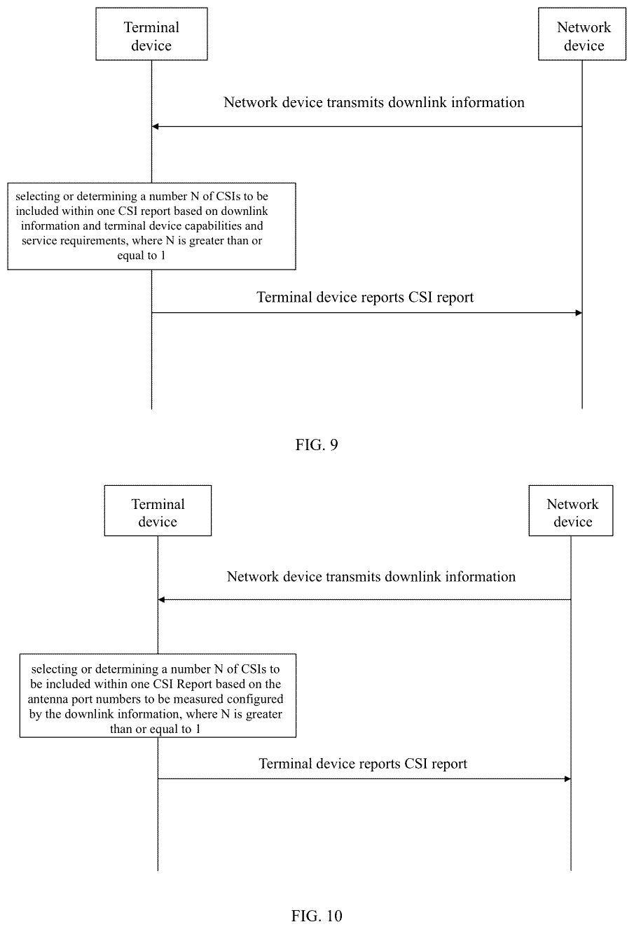

As shown in FIG. 9, based on any of the above embodiments, a fifth embodiment of the present application is provided, including:
the network device transmits downlink information so that the terminal device selects or determines a number N of CSIs to be included within one CSI report based on the downlink information, where N is greater than or equal to 1.

Optionally, the terminal device selects or determines the number N of CSIs to be included within one CSI report based on the downlink information.

The terminal device reports the CSI report.

Optionally, the downlink information includes at least one of the following:
downlink control information;
radio resource control information; and
media access control information.

Optionally, the number N of CSI to be included within one CSI report is determined by at least one of the following:
determining N according to an indication field in the downlink control information that specifies a preferred number of channel state information;
determining N according to an antenna port numbers to be measured configured by the downlink information; and
determining N according to terminal device capabilities and service requirements.

Optionally, N is less than or equal to the antenna port numbers to be measured configured by the downlink information.

Optionally, a CSI Report includes at least one of the following:
information of antenna port number indicator, where the antenna port number indicator indicates N different antenna port numbers corresponding respectively to the N CSIs; and
the N CSIs corresponding respectively to N different antenna port numbers, where at least one CSI in the N CSIs includes a wideband channel quality indicator and/or a rank indicator.

Optionally, the antenna port number indicator includes at least one of the following:
a CSI-RS resource identifier field corresponding to N different antenna port numbers;
a CSI-RS resource set identifier field corresponding to N different antenna port numbers;
a logical index number field of a CSI-RS resource identifier corresponding to N different antenna port numbers;
a logical index number field of a CSI-RS resource set identifier corresponding to N different antenna port numbers; and
an index position field of N different antenna port numbers in a resource pool.

Optionally, the terminal device selects or determines a number N of CSIs to be included within one CSI report based on downlink information and terminal device capabilities and service requirements, where N is greater than or equal to 1.

Optionally, if the terminal device determines, according to downlink control information, radio resource control information, and/or media access control information, that the antenna port numbers to be measured include 32 ports, 16 ports, 12 ports, 8 ports, 4 ports, and 2 ports, the terminal device first acquires, based on the downlink control information and/or radio resource control information transmitted by the network device, the time-frequency domain resources of non-zero power CSI-RS corresponding to each antenna port number to be measured, and measures the non-zero power CSI-RS corresponding to each antenna port number to be measured, thereby obtaining the channel reception quality corresponding to each antenna port number to be measured. The terminal device then ranks the channel reception quality corresponding to each antenna port number to be measured. If the number N of preferred antenna port numbers to be reported is determined by the terminal device based on its service processing and service requirements, the terminal device reports to the network device the antenna port number indicators corresponding to the top N antenna port numbers with the best channel reception quality, together with a wideband channel quality indicator and/or a rank indicator corresponding to at least one of the top N antenna port numbers with the best channel reception quality.

Optionally, the value of N, representing the number of preferred antenna port numbers to be reported, which is determined by the terminal device based on its service processing and service requirements, may be related to the channel reception quality. For example, among all the antenna port numbers, if the number K of antenna port numbers having channel reception quality exceeds a certain threshold is greater than or equal to 1, the terminal device determines that the number N of preferred antenna port numbers to be reported is equal to K.

Optionally, the value of N, representing the number of preferred antenna port numbers to be reported, which is determined by the terminal device, may be determined according to the current uplink service requirements of the terminal device. For example, when the amount of data to be transmitted for uplink service transmission is relatively large, the terminal device may select a smaller number N of antenna port numbers to be reported, so as to reduce the overhead of the uplink CSI report and reserve more uplink resources for uplink service transmission. When the amount of data to be transmitted for uplink service transmission is greater than a second threshold, the number N of antenna port numbers to be reported selected by the terminal device may be 2, 3, or other values. When the amount of data to be transmitted for uplink service transmission is less than the second threshold, the number N of antenna port numbers to be reported selected by the terminal device may be 5, 6, or other values.

It should be noted that the above values of N=2 or 3, or N=5 or 6, are provided only as examples, and the actual values shall be subject to the definition values in the system.

Optionally, the specific threshold and the specific number of reported antenna ports may be adjusted according to actual conditions.

It should be noted that the antenna port number indicators corresponding to multiple CSIs in the CSI report determined in the fifth embodiment may also be determined in combination with the methods described in the second to fourth embodiments.

In the technical solution of this embodiment: the terminal device selects or determines a number N of CSIs to be included within one CSI report based on the downlink information transmitted by the network device and terminal device capabilities and service requirements, where N is greater than or equal to 1, and reports the CSI report so as to achieve the purpose of reducing the number of CSI reports, reducing CSI report overhead, and/or ensuring CSI timeliness.

### Sixth Embodiment

As shown in FIG. 10, based on any of the above embodiments, a sixth embodiment of the present application is provided, including:
the network device transmits downlink information so that the terminal device selects or determines a number N of CSIs to be included within one CSI report based on the downlink information, where N is greater than or equal to 1.

The terminal device selects or determines the number N of CSIs to be included within one CSI report based on the downlink information.

The terminal device reports the CSI report.

Optionally, the downlink information includes at least one of the following:
downlink control information;
radio resource control information; and
media access control information.

Optionally, the number N of CSI to be included within one CSI report is determined by at least one of the following:
determining N according to an indication field in the downlink control information that specifies a preferred number of channel state information;
determining N according to an antenna port numbers to be measured configured by the downlink information; and
determining N according to terminal device capabilities and service requirements.

Optionally, N is less than or equal to the antenna port numbers to be measured configured by the downlink information.

Optionally, a CSI Report includes at least one of the following:
information of antenna port number indicator, where the antenna port number indicator indicates N different antenna port numbers corresponding respectively to the N CSIs; and
the N CSIs corresponding respectively to N different antenna port numbers, where at least one CSI in the N CSIs includes a wideband channel quality indicator and/or a rank indicator.

Optionally, the antenna port number indicator includes at least one of the following:
a CSI-RS resource identifier field corresponding to N different antenna port numbers;
a CSI-RS resource set identifier field corresponding to N different antenna port numbers;
a logical index number field of a CSI-RS resource identifier corresponding to N different antenna port numbers;
a logical index number field of a CSI-RS resource set identifier corresponding to N different antenna port numbers; and
an index position field of N different antenna port numbers in a resource pool.

Optionally, the terminal device selects or determines the number N of CSIs to be included within one CSI report based on the antenna port numbers to be measured configured by the downlink information, where N is greater than or equal to 1.

Optionally, according to downlink control information, radio resource control information, and/or media access control information, the antenna port numbers to be measured include 32 ports, 16 ports, 12 ports, 8 ports, 4 ports, and 2 ports. The terminal device acquires, based on the downlink control information and/or radio resource control information transmitted by the network device, the time-frequency domain resources of non-zero power CSI-RS corresponding to each antenna port number to be measured, and measures the non-zero power CSI-RS corresponding to each antenna port number to be measured, thereby obtaining the channel reception quality corresponding to each antenna port number to be measured. The terminal device then reports, to the network device, the antenna port number indicators corresponding to all antenna port numbers to be measured, and a wideband channel quality indicator and/or a rank indicator corresponding to at least one of the antenna port numbers to be measured.

It should be noted that the antenna port number indicators corresponding to multiple CSIs in the CSI report determined in the sixth embodiment may also be determined in combination with the methods described in the second to fourth embodiments.

In the technical solution of this embodiment: the terminal device first acquires, based on the downlink information transmitted by the network device, a number X of antenna port numbers to be measured, where X is greater than or equal to 1. The terminal device then selects or determines that the number N of CSIs to be included within one CSI report is equal to X, where N is greater than or equal to 1, and reports the CSI report so as to achieve the purpose of reducing CSI reporting frequency and/or ensuring CSI timeliness.

### Seventh Embodiment

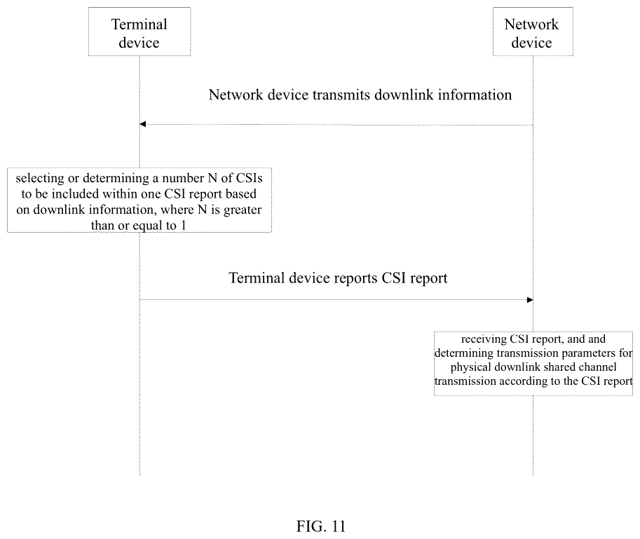

As shown in FIG. 11, based on any of the above embodiments, a seventh embodiment of the present application is provided, including:
the network device transmits downlink information so that the terminal device selects or determines a number N of CSIs to be included within one CSI report based on the downlink information, where N is greater than or equal to 1.

The terminal device selects or determines a number N of CSIs to be included within one CSI report based on the downlink information, where N is greater than or equal to 1. The terminal device reports the CSI report.

The network device receives the CSI report and determines transmission parameters for physical downlink shared channel transmission according to the CSI report.

Optionally, the downlink information includes at least one of the following:
downlink control information;
radio resource control information; and
media access control information.

Optionally, the number N of CSI to be included within one CSI report is determined by at least one of the following:
determining N according to an indication field in the downlink control information that specifies a preferred number of channel state information;
determining N according to an antenna port numbers to be measured configured by the downlink information; and
determining N according to terminal device capabilities and service requirements.

Optionally, N is less than or equal to the antenna port numbers to be measured configured by the downlink information.

Optionally, a CSI report includes at least one of the following:
information of antenna port number indicator, where the antenna port number indicator indicates N different antenna port numbers corresponding respectively to the N CSIs; and
the N CSIs corresponding respectively to N different antenna port numbers, where at least one CSI in the N CSIs includes a wideband channel quality indicator and/or a rank indicator.

Optionally, the antenna port number indicator includes at least one of the following:
a CSI-RS resource identifier field corresponding to N different antenna port numbers;
a CSI-RS resource set identifier field corresponding to N different antenna port numbers;
a logical index number field of a CSI-RS resource identifier corresponding to N different antenna port numbers;
a logical index number field of a CSI-RS resource set identifier corresponding to N different antenna port numbers; and
an index position field of N different antenna port numbers in a resource pool.

Optionally, the transmission parameters include at least one of the following:
the rank used for PDSCH transmission;
the modulation and coding scheme used for the PDSCH transmission;
the precoding matrix used for the PDSCH transmission; and
the number of antenna ports used for the PDSCH transmission.

In the technical solution of the present application, the terminal device selects or determines a number N of CSIs to be included within one CSI report based on the downlink information transmitted by the network device, where N is greater than or equal to 1, and reports the CSI report. The network device receives the CSI report and determines transmission parameters for PDSCH transmission based on the CSI report, thereby achieving the purpose of reducing CSI reporting frequency and/or ensuring CSI timeliness; and/or, reporting channel state information corresponding to the antenna port numbers enables the network device to determine the transmission parameters used for the PDSCH transmission.

It should be noted that the above embodiments may be reasonably combined according to actual situations, and detailed descriptions thereof are omitted herein.

The embodiments of the present application further provide a processing apparatus, which is applied to or constitutes a terminal device, the apparatus including:
a determination module configured to select or determine, based on downlink information, a number N of CSIs to be included within one CSI report, where N is greater than or equal to 1; and
a reporting module configured to report the CSI report.

Optionally, the downlink information includes at least one of the following:
downlink control information;
radio resource control information; and
media access control information.

Optionally, the determination module further includes at least one of the following:
determining N according to an indication field in the downlink control information that
specifies a preferred number of channel state information;
determining N according to an antenna port numbers to be measured configured by the downlink information;
determining N according to terminal device capabilities and service requirements; and
N being less than or equal to the antenna port numbers to be measured configured by the downlink information.

Optionally, the CSI Report includes at least one of the following:
information of antenna port number indicator, where the antenna port number indicator indicates N different antenna port numbers corresponding respectively to the N CSIs; and
the N CSIs corresponding respectively to N different antenna port numbers, where at least one CSI in the N CSIs includes a wideband channel quality indicator and/or a rank indicator.

Optionally, the antenna port number indicator includes at least one of the following:
a CSI-RS resource identifier field corresponding to N different antenna port numbers;
a CSI-RS resource set identifier field corresponding to N different antenna port numbers;
a logical index number field of a CSI-RS resource identifier corresponding to N different antenna port numbers;
a logical index number field of a CSI-RS resource set identifier corresponding to N different antenna port numbers; and
an index position field of N different antenna port numbers in a resource pool.

The embodiments of the present application further provide a processing apparatus, which is applied to or constitutes a network device, the apparatus including:
a transmitting module configured to transmit downlink information so that a terminal device selects or determines, based on the downlink information, a number N of CSIs to be included within one CSI report.

Optionally, the downlink information includes at least one of the following:
downlink control information;
radio resource control information; and
media access control information.

Optionally, the CSI report includes at least one of the following:
information of antenna port number indicator, where the antenna port number indicator indicates N different antenna port numbers corresponding respectively to the N CSIs; and
the N CSIs corresponding respectively to N different antenna port numbers, where at least one CSI in the N CSIs includes a wideband channel quality indicator and/or a rank indicator.

Optionally, the antenna port number indicator includes at least one of the following:
a CSI-RS resource identifier field corresponding to N different antenna port numbers;
a CSI-RS resource set identifier field corresponding to N different antenna port numbers;
a logical index number field of a CSI-RS resource identifier corresponding to N different antenna port numbers;
a logical index number field of a CSI-RS resource set identifier corresponding to N different antenna port numbers; and
an index position field of N different antenna port numbers in a resource pool.

Optionally, the apparatus further includes:
a receiving module configured to receive the CSI report and determine transmission parameters for PDSCH transmission based on the CSI report.

Optionally, the transmission parameters include at least one of the following:
a rank used for Physical Downlink Shared Channel (PDSCH) transmission;
a modulation and coding scheme used for PDSCH transmission;
a precoding matrix used for PDSCH transmission; and
a number of antenna ports used for PDSCH transmission.

An embodiment of the present application further provides a communication system, including the terminal device described in any of the above embodiments, and the network device described in any of the above embodiments.

An embodiment of the present application further provides a communication device, including: a memory, a processor, and a processing program stored in the memory and executable on the processor, and the processing program is executed by the processor to implement the processing method described in any of the above embodiments.

The communication device mentioned in the present application can be a terminal device (such as a smart terminal, such as a mobile phone) or a network device (such as a base station). The specific reference needs to be clarified in combination with the context.

The embodiment of the present application further provides a storage medium, a processing program is stored in the storage medium, and when the processing program is executed by the processor, the steps of the processing method in any of the above embodiments are implemented.

In the embodiment of the communication device and the storage medium provided in the embodiments of the present application, all technical features of any of the above-mentioned image processing method embodiments may be included, and the expansion and explanation content of the specification are basically the same as the embodiments of the above-mentioned methods, and will not be repeated here.

An embodiment of the present application further provides a computer program code, which includes a computer program code, and when the computer program code is run on a computer, the computer executes the method in the above-mentioned various possible implementations.

An embodiments of the present application further provide a chip, including a memory and a processor, the memory is configured to store a computer program, and the processor is configured to call and run the computer program from the memory, so that the device equipped with the chip executes the method in the above-mentioned various possible implementations.

It can be understood that the above-mentioned scenarios are only examples and do not constitute a limitation on the application scenarios of the technical solutions provided in the embodiments of the present application. The technical solutions of the present application can also be applied to other scenarios. For example, it is known to ordinary technicians in the field that with the evolution of the system architecture and the emergence of new business scenarios, the technical solutions provided in the embodiments of the present application are also applicable to similar technical problems.

The serial numbers of the embodiments of the present application are for description only and do not represent the advantages and disadvantages of the embodiments.

The steps in the method of the embodiment of the present application can be adjusted in order, merged and deleted according to actual needs.

The units in the device of the embodiment of the present application can be merged, divided and deleted according to actual needs.

In the present application, the same or similar terminology, technical solution and/or application scenario description is generally described in detail only when it appears for the first time. When it appears again later, it is generally not repeated for the sake of brevity. When understanding the technical solution and other contents of the present application, for the same or similar terminology, technical solution and/or application scenario description that is not described in detail later, please refer to the previous related detailed description.

In the present application, the descriptions of various embodiments have different focuses. For parts that are not described or recorded in a certain embodiment, please refer to the relevant descriptions of other embodiments.

The various technical features of the technical solution of the present application can be combined arbitrarily. In order to make the description concise, all possible combinations of the various technical features in the above embodiments are not described. However, as long as there is no contradiction in the combination of these technical features, they should be considered to be within the scope of the present application.

Through the above description of the implementation, those skilled in the art can clearly understand that the above embodiment methods can be implemented by software plus the necessary general hardware platform, or by hardware, but in many cases the former is a better implementation. Based on this understanding, the technical solution of the present application essentially or the part that contributes to the existing technology can be embodied in the form of a software product, and the computer software product is stored in one of the above storage media (such as ROM/RAM, disk, optical disk), including several instructions to cause a terminal device (which can be a mobile phone, a computer, a server, a controlled terminal, or a network device, etc.) to execute the method of each embodiment of the present application.

The above embodiments can be implemented in whole or in part by software, hardware, firmware or any combination thereof. When implemented by software, it can be implemented in whole or in part in the form of a computer program product. The computer program product includes one or more computer instructions. When the computer program instructions are loaded and executed on the computer, the process or function according to the embodiment of the present application is generated in whole or in part. The computer can be a general-purpose computer, a special-purpose computer, a computer network, or other programmable device. The computer instructions can be stored in a computer-readable storage medium, or transmitted from one computer-readable storage medium to another computer-readable storage medium. For example, the computer instructions can be transmitted from one website, computer, server or data center to another website, computer, server or data center by wired (such as coaxial cable, optical fiber, digital subscriber line) or wireless (such as infrared, wireless, microwave, etc.) means. The computer-readable storage medium can be any available medium that can be accessed by the computer or a data storage device such as a server or data center that includes one or more available media integrated. The available medium can be a magnetic medium (such as a floppy disk, a storage disk, a tape), an optical medium (such as a DVD), or a semiconductor medium (such as a Solid State Disk (SSD)), etc.

The above are only some embodiments of the present application, and are not intended to limit the scope of the present application. Any equivalent structure or equivalent process transformation made using the contents of the specification and drawings of the present application, or directly or indirectly applied in other related technical fields, shall be similarly included in the scope of the present application.

What is claimed is:

1. A processing method, comprising:
selecting or determining a number N of channel state information (CSI) to be comprised within one CSI report based on downlink information, wherein N is greater than or equal to 1; and
reporting the CSI report.

2. The method according to claim 1, wherein the downlink information comprises at least one of the following:
downlink control information;
radio resource control information; and
media access control information.

3. The method according to claim 2, wherein the selecting or determining the number N of CSIs to be comprised within the CSI report based on the downlink information comprises at least one of the following:
determining N according to an indication field in the downlink control information that specifies a preferred number of channel state information;
determining N according to antenna port numbers to be measured configured by the downlink information; and
determining N according to the downlink information, terminal device capabilities and service requirements; and
determining N according to the antenna port numbers to be measured configured by the radio resource control information.

4. The method according to claim 1, wherein the CSI report comprises at least one of the following:
information of antenna port number indicator, wherein the antenna port number indicator indicates N different antenna port numbers corresponding respectively to the N CSIs; and
the N CSIs corresponding respectively to N different antenna port numbers, wherein at least one CSI in the N CSIs comprises a wideband channel quality indicator and/or a rank indicator.

5. The method according to claim 4, wherein the antenna port number indicator comprises at least one of the following:
a channel state information-Reference Signal (CSI-RS) resource identifier field corresponding to N different antenna port numbers;
a CSI-RS resource set identifier field corresponding to N different antenna port numbers;
a logical index number field corresponding to N different antenna port numbers;
a logical index number field of a CSI-RS resource identifier corresponding to N different antenna port numbers;
a logical index number field of a CSI-RS resource set identifier corresponding to N different antenna port numbers; and
an index position field of N different antenna port numbers in a resource pool.

6. The method according to claim 4, wherein at least one of the following holds:
CSI-RSs corresponding to N different antenna port numbers have the same non-zero-power channel state information reference signal resource identifier;
CSI-RSs corresponding to N different antenna port numbers have different non-zero-power channel state information reference signal resource identifier;
N is less than or equal to the antenna port numbers to be measured in downlink information configuration; and
a logical index number field meets a first preset rule.

7. The method according to claim 6, wherein the meeting the first preset rule comprises at least one of the following:
determining a logical index of each antenna port number to be measured by sorting antenna ports to be measured from largest to smallest;
determining the logical index of each antenna port number to be measured by sorting the antenna ports to be measured from smallest to largest;
determining the logical index of each antenna port number to be measured by sorting CSI-RS resource set identifiers corresponding to the antenna ports to be measured from smallest to largest;
determining the logical index of each antenna port number to be measured by sorting the CSI-RS resource set identifiers corresponding to the antenna ports to be measured from largest to smallest;
determining the logical index of each antenna port number to be measured by sorting the CSI-RS resource identifiers corresponding to the antenna ports to be measured from smallest to largest; and
determining the logical index of each antenna port number to be measured by sorting the CSI-RS resource identifiers corresponding to the antenna ports to be measured from largest to smallest.

8. The method according to claim 1, further comprising:
obtaining a time-frequency domain resource of a non-zero power channel state information reference signal corresponding to each number of antenna ports to be measured according to at least one of downlink control information, radio resource control information, and media access control information.

9. A processing method, comprising:
transmitting downlink information so that a terminal device selects or determines a number N of channel state information (CSI) s to be comprised within one CSI report based on the downlink information, wherein N is greater than or equal to 1.

10. The method according to claim 9, wherein the downlink information comprises at least one of the following:
downlink control information;
radio resource control information; and
media access control information.

11. The method according to claim 10, wherein the terminal device selecting or determining the number N of CSIs to be comprised within the CSI report based on the downlink information comprises at least one of the following:
the terminal device determining N according to an indication field in the downlink control information that specifies a preferred number of channel state information;
the terminal device determining N according to an antenna port numbers to be measured configured by the downlink information; and
the terminal device determining N according to the downlink information, terminal device capabilities and service requirements.

12. The method according to claim 9, wherein the CSI report comprises at least one of the following:
information of antenna port number indicator, wherein the antenna port number indicator indicates N different antenna port numbers corresponding respectively to the N CSIs; and
the N CSIs corresponding respectively to N different antenna port numbers, wherein at least one CSI in the N CSIs comprises a wideband channel quality indicator and/or a rank indicator.

13. The method according to claim 12, wherein the antenna port number indicator comprises at least one of the following:
a channel state information-reference signal (CSI-RS) resource identifier field corresponding to N different antenna port numbers;
a CSI-RS resource set identifier field corresponding to N different antenna port numbers;
a logical index number field corresponding to N different antenna port numbers;
a logical index number field of a CSI-RS resource identifier corresponding to N different antenna port numbers;
a logical index number field of a CSI-RS resource set identifier corresponding to N different antenna port numbers; and
an index position field of N different antenna port numbers in a resource pool.

14. The method according to claim 12, wherein at least one of the following holds:
CSI-RSs corresponding to N different antenna port numbers have the same non-zero-power channel state information reference signal resource identifier;
CSI-RSs corresponding to N different antenna port numbers have different non-zero-power channel state information reference signal resource identifier;
N is less than or equal to the antenna port numbers to be measured in downlink information configuration; and
a logical index number field meets a first preset rule.

15. The method according to claim 14, wherein the meeting the first preset rule comprises at least one of the following:
determining a logical index of each antenna port number to be measured by sorting antenna ports to be measured from largest to smallest;
determining the logical index of each antenna port number to be measured by sorting the antenna ports to be measured from smallest to largest;
determining the logical index of each antenna port number to be measured by sorting CSI-RS resource set identifiers corresponding to the number of antenna ports to be measured from smallest to largest;
determining the logical index of each antenna port number to be measured by sorting the CSI-RS resource set identifiers corresponding to the number of antenna ports to be measured from largest to smallest; and
determining the logical index of each antenna port number to be measured by sorting CSI-RS resource identifiers corresponding to the number of antenna ports to be measured from smallest to largest.

16. The method according to claim 9, further comprising:
receiving a CSI report; and determining transmission parameters for physical downlink shared channel transmission according to the CSI report.

17. The method according to claim 9, wherein:
at least one of the downlink control information, radio resource control information and media access control information is used for the terminal device to obtain a time-frequency domain resource of a non-zero power channel state information reference signal corresponding to each number of antenna ports to be measured.

18. A communication device, comprising: a memory and a processor, wherein a processing program is stored in the memory, and when the processing program is executed by the processor, the processing method according to claim 1 is implemented.

19. A communication device, comprising: a memory and a processor, wherein a processing program is stored in the memory, and when the processing program is executed by the processor, the processing method according to claim 9 is implemented.

20. A non-transitory computer-readable storage medium, wherein a computer program is stored in the storage medium, and when the computer program is executed by a processor, the processing method according to claim 1 is implemented.
